(19) United States
(12) Patent Application Publication
(10) Pub. No.: US 2002/0133624 A1
(43) Pub. Date: Sep. 19, 2002

(54) System and process for routing information in a data processing system

(76) Inventors: Tony Hashem, Lynchburg, VA (US); Donald James Freeman, Lynchburg, VA (US); David Wood, Goode, VA (US); David Helt, Forest, VA (US)

Correspondence Address: Jennifer A.Albert, Esq., Hunton & Williams, 1900 K Street, N.W., Washington, DC, 20006, US

(21) Appl. No.: 09/760,296

(22) Filed: Jan. 16, 2001

(51) Int. Cl. G06F 15/173

(52) U.S. Cl. 709/243

(57) ABSTRACT

A system and process for routing information in a data processing system. The process includes the steps of checking an inbox periodically to determine if new data has been received in the inbox, determining a destination for the new data based on a routing table associated with the inbox if new data has been received in the inbox, and transmitting the new data to the determined destination.

### BACKGROUND OF THE INVENTION

This invention relates generally to data processing systems, and more particularly to routing information in data processing systems.

As data processing systems become paperless, the ability of a data processing system to handle paperless input is dependent upon the data processing system's ability to accept different formats for the information the data processing system receives. The data processing system may be required to be able to handle data and documents from a variety of sources.

In some existing data processing systems, new programs need to be written each time new systems are added to the data processing system or each time changes in the system are made. The time involved in writing a program to accommodate changes in the data processing system may be lengthy. Writing programs for each such change increases expenses and lowers efficiency for the data processing system.

### BRIEF SUMMARY OF THE INVENTION

A system and process for routing information in a data processing system is described. The process includes the steps of checking an inbox periodically to determine if new data has been received in the inbox; determining a destination for the new data based on a routing table associated with the inbox if new data has been received in the inbox; and transmitting the new data to the determined destination.

In another aspect of the invention, a system for routing information in a data processing system is provided. The system comprises an information router for routing a data package including a package examination engine for reading a descriptor file for the data package including descriptive information about the data package; a decision engine for comparing the descriptive information in the descriptor file to routing information in a routing table; and a routing table engine to route the data package to a destination system based on the routing information from the routing table, if the descriptive information in the descriptor file matches a routing information entry in the routing table, and to follow an internal error procedure if the descriptive information in the descriptor file does not match a routing information entry in the routing table or if there is a package error.

### BRIEF DESCRIPTION OF THE DRAWINGS

FIG. 1 is a block diagram illustrating a system using an information router in accordance with an embodiment of the invention;

FIG. 2 is a block diagram of an information router according to one embodiment of this invention;

FIG. 3 is a flow diagram illustrating the steps performed in a process for routing information in a data processing system according to an embodiment of the invention;

FIG. 4 is one embodiment of a routing table;

FIG. 5 is a flow diagram illustrating the steps performed in a process for monitoring data packages routed through an information router according to an embodiment of the invention; and

FIG. 6 is a flow diagram illustrating the steps performed during a process for submitting data to a data processing system including an information router according to an embodiment of the invention.

### DETAILED DESCRIPTION OF THE INVENTION

Reference will now be made in detail to the present preferred embodiments of the invention, examples of which are illustrated in the accompanying drawings in which like reference characters refer to corresponding elements.

The present invention is described in relation to a system and process for routing information in a data processing system. Nonetheless, the characteristics and parameters pertaining to the system and process of the invention may be applicable to routing information in other types of systems.

In terms of the general environment and resources in or with which the data processing system of the invention may operate, the system may include a data bus or other communication mechanism for communicating information and a processor coupled to the bus for processing information. The system may also include a main memory, such as a random access memory (RAM) or other dynamic storage device, coupled to the bus for storing information and instructions to be executed by the processor. The main memory also may be used for storing one or more temporary variables or other intermediate information during execution of the instructions by the processor. The system may further include a read only memory (ROM) or other static storage device coupled to the bus for storing static information and instructions for the processor. A storage device such as a magnetic disk or an optical disk may be provided and coupled to the bus for storing information and instructions.

The system may be coupled via the bus to a display, such as a cathode ray tube (CRT), a liquid crystal display (LCD) or other device, for displaying information to a system user. An input device, including a plurality of alphanumeric and other keys, may be coupled to the bus for communicating information and command selections to the processor. Another type of input device is a cursor control, such as a mouse, a trackball, or a plurality of cursor direction keys for communicating directional information and command selections to the processor and for controlling cursor movement on the display. The input device typically has two degrees of freedom in two axes, a first axis (e.g., an x axis) and a second axis (e.g., a y axis), that allows the input device to specify a plurality of positions in a plane.

The system for routing information in a data processing system of the invention may use a computer, a network and other resources. According to one embodiment of the invention, the routing of information in the data processing system may be conducted via the system in response to the processor executing one or more sequences of one or more instructions stored in the main memory.

Such instructions may be read into the main memory from another computer-readable medium, such as the static storage device. Execution of the sequences of instructions stored in the main memory causes the processor to perform the process steps described herein. One or more processors in a multi-processing arrangement may also be employed to execute the sequences of instructions stored in the main memory. In alternative embodiments, hard-wired circuitry may be used in place of, or in combination with, software instructions to implement the invention. Thus, embodiments of the invention are not limited to any specific combination of hardware circuitry or software.

The term “computer-readable medium” as used herein refers to any medium that participates in providing instructions to the processor for execution. Such a medium may take many forms, including but not limited to, a non-volatile medium, a volatile medium, and a transmission medium. The non-volatile medium may include a dynamic memory, such as the main memory. The transmission medium may include a coaxial cable, a copper wire and a fiber optic network, including the one or more wires that comprise the bus. The transmission medium may also take the form of a plurality of acoustic or light waves, such as those generated during radio frequency (RF) and infrared data communications. Common forms of computer-readable media include, for example, a floppy disk, a flexible disk, a hard disk, a magnetic tape or any other magnetic medium, a CD-ROM, a DVD, or any other optical medium, one or more punch cards, a paper tape, or any other physical medium with patterns of holes, a RAM, a programmable read-only memory (PROM), an electrically-programmable read-only memory (EPROM), a FLASH-EPROM, any other memory chip or a cartridge, a carrier wave as described hereinafter, or any other medium from which a computer can read data stored therein.

Various forms of computer readable media may be involved in executing the one or more sequences of one or more instructions by the processor. For example, the instructions may initially be borne on a magnetic disk of a remote computer. The remote computer can load the instructions into its dynamic memory and can send the instructions over a telephone line using a modem. A modem local to the system can receive the data on the telephone line and can use an infrared transmitter to convert the data to an infrared signal. An infrared detector coupled to the bus can receive the data carried in the infrared signal and can place the data on the bus. The bus carries the data to the main memory from which the processor retrieves and executes the instructions. The instructions received by the main memory may optionally be stored on a storage device as described herein, either before or after execution by the processor.

The system may also include a communication interface coupled to the data bus. The communication interface provides a two-way data communication coupling to a network link that is connected to a local network or another network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links also may be implemented. In any such implementation, the communication interface sends and receives electrical, electromagnetic or optical signals that carry digital data streams representing various types of information.

The network link typically provides data communication through one or more networks to other data devices. For example, the network link may provide a connection through a local network to a host computer, server or to other data equipment operated by an Internet Service Provider (ISP) or another entity. The ISP may in turn provide data communication services through the worldwide package data communication network, now commonly referred to as the “Internet”. The local network and the Internet both use electrical, electromagnetic or optical signals that carry digital data streams. The signals through the various networks and the signals on the network link and through the communication interface which carry the digital data to and from the system, are exemplary forms of carrier waves transporting the information.

The system can send messages and receive data, including program code, through the network(s), the network link, and the communication interface. For example, a server might transmit requested code for an application program through the Internet, an Internet Service Provider (ISP), a local network and the communication interface. In accordance with the invention, one such downloaded application program provides for operating and maintaining the system described herein. The received code may be executed by the processor as it is received and/or stored in a storage device for later execution. In this manner, the system may obtain code for the application program via a carrier wave or other communications means.

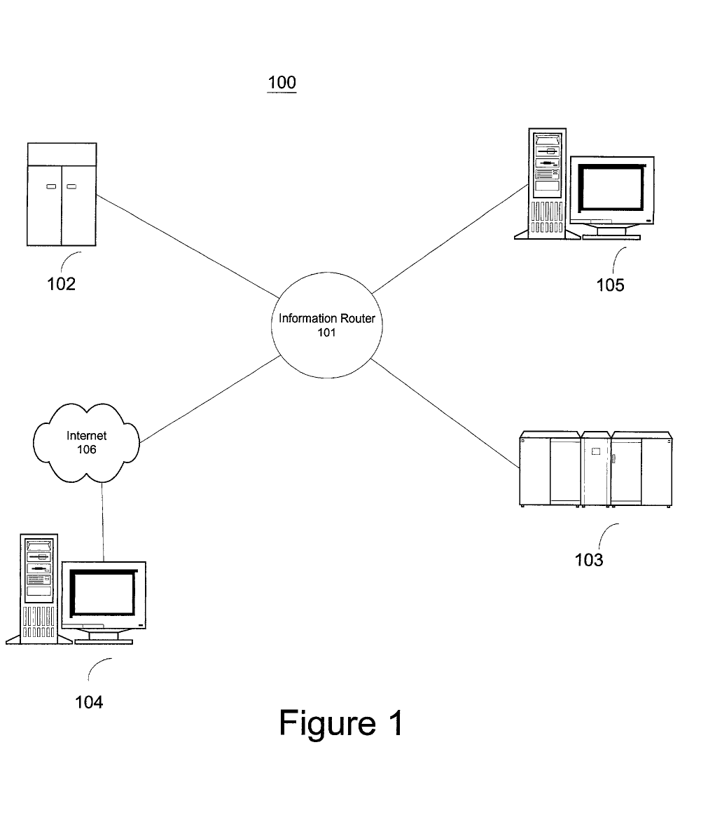

FIG. 1 is a block diagram illustrating one embodiment of a system using an information router of the present invention. System 100 includes an information router 101, a data processing system 102, a mainframe 103, and external systems 104 and 105. The data processing system 102 may be any type of data processing system such as, for example, an imaging system. The external system 104 may provide one or more dedicated data feeds to the information router 101, and thus, to the data processing system 102. The external system 105 may provide data over the Internet 106. The external systems 104 and 105 may provide any type of data such as, for example, supplier data.

The data processing system 102 may receive data or documents from the external systems 104 and 105 through the information router 101. The information router 101 may be linked to the data processing system 102, the mainframe 103, the external system 104, and the Internet 106.

The information router 101 may receive data from the external systems 104 and 105 and may then decide, based on a descriptor file attached to the received data, to which destination system the data from the external systems 104 and 105 should be routed. The external systems 104 and 105 need only format their data to interact with the information router 101. The external systems 104 and 105 also will only receive one type of formatted data from one source, the information router 101. Thus, the data processing system 102 and the external systems 104 and 105 no longer need to support multiple communications platforms to send and receive data. The information router 101 may take care of the routing necessary to get data to and from the intended systems 102, 104 and 105.

For example, the processing system 102 may receive data from various sources such as from the external system 105 through the Internet 106 or from dedicated data feeds from the external system 104. Regardless of the sources of the data, the data processing system 102 must support communications with the external systems 104 and 105. With the information router 101 connected, however, the data processing system 102 and the external systems 104 and 105 need only communicate with the information router 101. Thus, systems 102, 104, and 105 may be unaware of what other systems may also be connected beyond the information router 101.

The mainframe 103 may store data and other information for use by the data processing system 102. For example, the mainframe 103 may store one or more numbers designating important documents which the data processing system 102 may request to look up.

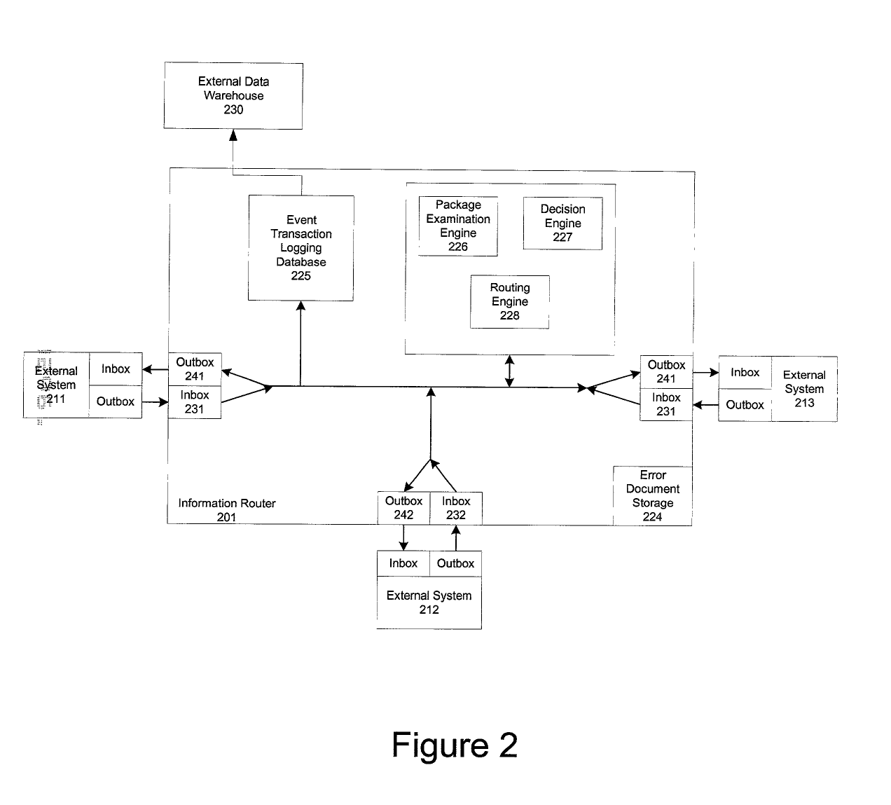

FIG. 2 is a block diagram illustrating one embodiment of an information router. As shown in FIG. 2, an information router 201 may be coupled to exchange data with a plurality of external systems 211-213. The information router 201 may include a series of inboxes 231-233 and a series of outboxes 241-243, a package examination engine 226, a decision engine 227, a routing engine 228, an error document storage directory 224, and an event transaction logging database 225. The event transaction logging database 225 may be coupled to an external data warehouse 230.

As data and/or documents (“data”) arrive at the information router 201, the data may be placed in one of the inboxes 231-233. Each of the inboxes 231-233 may be constantly checked by the information router 201 to determine whether new data has arrived in any of the inboxes 231-233. If the information router 201 finds new data in any of the inboxes 231-233, the information router 201 may look up a routing table associated with one of the inboxes 221-223 in which the data has arrived.

The information router 201 may use information in a descriptor file of the newly-arrived data to look up one or more rules for routing the newly-arrived data in the routing table associated with the one of the inboxes 231-233 in which the newly-arrived data is found. The information router 201 may then route the newly-arrived data to a next destination system for processing until data no longer appears in any of the inboxes 231-233 of the information router 201. One of the external systems 211-213 may include the data processing system 102.

The information router 201 may accept any data from any of the external systems 211-213 and may route the data to any of the external systems 211-213. The information router 201 may also log all routing and transactional events in the event transaction logging database 225. The event transaction logging database 225 may be comprised of an Oracle or a SQL server database. The event transaction logging database 225 may be used to provide daily reports of volumes of data processed and may greatly assist with error resolution. If a document or data is stalled, or processing has failed in some way, using the event transaction logging database 225, a user may determine all of the transactional events which were completed with respect to the data before a failure occurred.

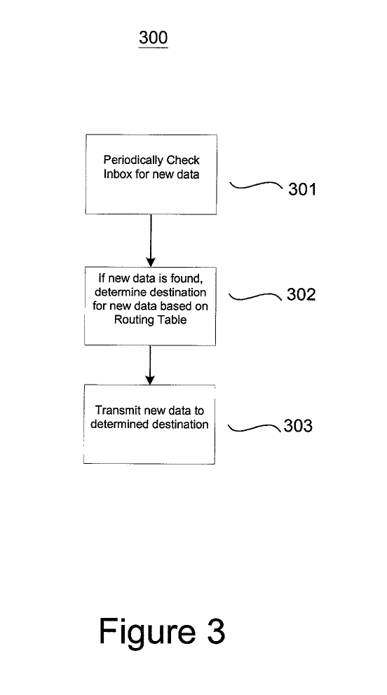

The steps performed during a process 300 for operation of the information router 201 will be explained with reference to FIG. 3. As will be described in more detail below, the various steps illustrated in FIG. 3 may be performed by a system, such as the system illustrated in FIGS. 1 and 2. Additionally, the sequence of steps shown in FIG. 3 may be modified in accordance with the present invention. The steps illustrated in FIG. 3 will now be described in greater detail.

At step 301, the information router 201 may periodically check each of the inboxes 231-233 for new data packages. The inboxes 231-233 may receive data packages from the external systems 211-213. The external systems 211-213 may transmit a data package directly to the inboxes 231-233, respectively, or each of the external systems 211-213 may place the data package to be transmitted to the information router 201 in an outbox 241, 242 or 243 of the respective external systems 211, 212 or 213. If the external systems 211, 212 or 213 place a data package to be transmitted to the information router 201 in the outbox 241, 242 or 243, the information router 201 may pull the data package from the outbox 241, 242 or 243 of the respective external system 211, 212, or 213 into a corresponding one of the inboxes 231, 232 or 233. Whether the external system 211, 212 or 213 places the data package in the outbox 241, 242 or 243 or in the inbox 231, 232, or 233 of the information router 201 may be determined by whether a push or pull operation is being used to get the data package to the information router 201.

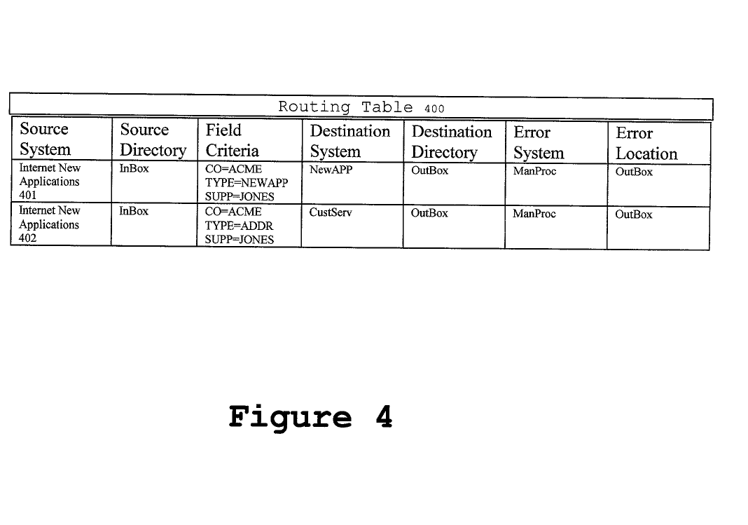

Each of the received data packages may include a descriptor file containing information about the data in the received data package. The descriptor file may be a text file. There need be no set format for the descriptor file. The descriptor file may include a plurality of fields that are predefined in a corresponding routing table in the information router 201 so that the information router 201 will know how to interpret the descriptor file and where to route the received data package. The descriptor file may contain a list of fields that tell the information router 201 something about the received data package. The information router 201 may read a value in each of the fields of the descriptor file and may perform operations based on a predefined set of rules found in a corresponding routing table of the inbox in which the received data package was placed on arrival at the information router 201. The descriptor file may contain any of the fields from the list of fields and the information router 201 may process the data in the received data package as long as there are a set of predefined processing rules in the routing table, as described below with reference to FIG. 4.

For example, the descriptor file may include the following contents:

| | |
|---|---|
| Name: | John Smith |
| Customer Number: | 1234 |
| Source: | JFL |
| Data type: | COA |
| Files attached: | |
| Doc 0534.tif | |
| Doc 0544.tif | |
| Doc 0545.tif | |

In the above example, a simple customer-related document was sent to the information router 201. This customer-related document may represent a simple change of address form for a customer. The key fields of the descriptor file may be a Source or a Data Type field. Also included in the descriptor file is a list of attached files. The information router 201 may read a value of each of these fields and may then route the customer-related document based on a routing rule. The routing rule may include a requirement that the attached files be routed along with the customer-related document to a final destination system.

If there is an error, such as an unrecognized value in the descriptor file or the customer-related document routed is missing the attachments, the information router 201 may be programmed to route the descriptor file and any attached files included to a special error directory 224 for manual intervention or to another attached subsystem to process the error.

The receipt of the data package in the one of the inboxes 231-233 may be recorded in the event transaction logging database 225. Any time the information router 201 performs an operation upon the data package, an event may be recorded in the event transaction logging database 225. The event recorded in the event transaction logging database 225 may be forwarded to the event data warehouse 230, if desired.

At step 302, the information router 201 may determine a destination system for the new data package received in the one of the inboxes 231-233 based on a routing table associated with the one of the inboxes 231-233 in which the data package was received. The information router 201 may transmit the data package from the one of the inboxes 231-233 in which it was received to the package examination engine 226.

The package examination engine 226 may read descriptive information included in the descriptor file of the new data package. The decision engine 227 may compare the information in the descriptor file to routing information included in a routing table associated with the one of the inboxes 231-233 in which the data package was received. If the descriptive information matches the routing information in the routing table, a destination system for the new package may be determined from the routing information in the matching entry of the routing table.

At step 303, the information router 201 may transmit the new data package to the determined destination system. The routing engine 228 may pick-up the new data package and send it to the determined destination system according to the routing information from the routing table. However, if a match is not found between the descriptive information and the routing information, or if there is a package error, the routing engine 228 may follow an error procedure from the routing table. The error procedure may either place the new data package into the internal error document storage directory 224, or may send the new data package to an external system for specialized handling. If the new data package is placed into the internal error document storage directory 224, the internal error document storage directory 224 may require manual intervention.

Thus, once the new data package has cleared the examination engine 226 and the decision engine 227, the routing engine 228 may place the new data package into either one of the outboxes 241-243 of the information router 201, or into an inbox 231-233 of one of the external systems 211-213 to continue processing to be done on that new data package. All of the transactional events performed on the new data package may be logged in the event transaction logging database 225. Once the new data package reaches one of the external systems 211-213, one of the external systems 211-213 may process the new data package and may send the new data package back to the information router 201 for further routing to another one of the external systems 211-213. If the new data package is returned to the information router 201 by one of the external systems 211-213, the entire process of FIG. 3 may start over.

FIG. 4 is a table illustrating one embodiment of a simplified routing table. A routing table 400 may be used in conjunction with a descriptor file of a data package to direct the information router 201 in routing the data package. The routing table 400 may be comprised of an internal instruction set that is created whenever a new type of data package is going to be processed. The components of the routing table may be defined by the user of the system. Thus, any type of data package may be routed by the information router 201. The routing table 400 may include a plurality of fields including a source system field, a source directory field, a field criteria field, a destination system field, a destination directory field, an error system field and an error location field.

In the example, two new data packages may be entering the information router 201 from the Internet 106. The information router 201 may detect that it has received new data packages 401 and 402 in one or more of the inboxes 231-233 and may begin to process the new data packages.

The information router 201 may then process the descriptor file of each of the new data packages 401 and 402 and try to find an exact match in the field criteria field for each of the new data packages 401 an 402. In the field criteria field of the routing table 400, CO may be a company to which a new data package is to be sent. TYPE may be a type of new data package to be sent and SUPP may be a name of a supplier from which the new data package was received. One difference between the two new data packages 401 and 402 is that one of the new data packages 401 is a NEWAPP and the other one of the new data packages 402 is an ADDR. NEWAPP may represent a new application program and ADDR may signify an address change. As shown in the routing table 400, the information router 201 may direct the new application, new data package 401, to a New App destination system and the address change, new data package 401, to a customer service destination system. If there is an error in one of the new data packages 401 or 402, one of the new data packages 401 or 402 may be routed to a ManProc destination system. The ManProc destination system may represent a manual processing destination system.

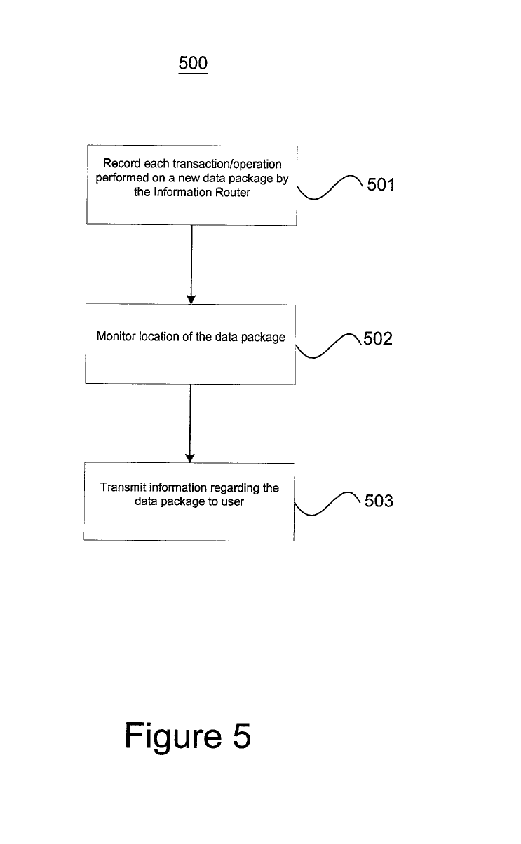

FIG. 5 is a flow diagram illustrating the steps performed during a process 500 for monitoring data packages routed through the information router 201 in accordance with an embodiment of the invention. As shown in FIG. 5, at step 501, each transactional operation performed by the information router 201 on a new data package received may be recorded in the event transaction logging database 225. Thus, each time a new data package arrives at one of the inboxes 231-233 of the information router 201, as the new data package is forwarded or routed to a destination system, these events may be recorded in the event transaction logging database 225. This recording step 501 allows the event transaction logging database 225 to build a complete tracking history of the processing and routing operations performed on the new data package similar to tracking methods used by couriers.

At step 502, the location of the new data package may be monitored. The event transaction logging database 225 may keep track of where each new data package is in the system, and may determine whether or not any new data packages are not properly forwarded to a destination system.

At step 503, information regarding the new data package may be transmitted to a user in response to a user request. The user may be able to look for any new data package that came into the information router 201 and determine the transactional events relating to the new data package, such as any stops made by the new data package at any intermediate systems, a time at which each stop was made and a destination system to which the new data package was ultimately routed.

With the use of a simple query tool, the user may determine a status of any new data package that is stalled in the system and may determine exactly where the new data package is within the system and where the new data package was supposed to have been forwarded or routed. The information router 201 may also have email capability with a report generator in the event transaction logging database 225. The email capability may be used to send an email message to the user. The email message may include one or more system statistics regarding any new data packages sitting in an error queue. Further, the event transaction logging database 225 may be connected to the external data warehouse 230 in order to download information concerning events stored in the event transaction logging database 225 on an hourly or a daily basis. Data from the information router 201 may be consolidated with data from the external systems 211-213 to build a complete picture of the movements of the new data packages through an organization.

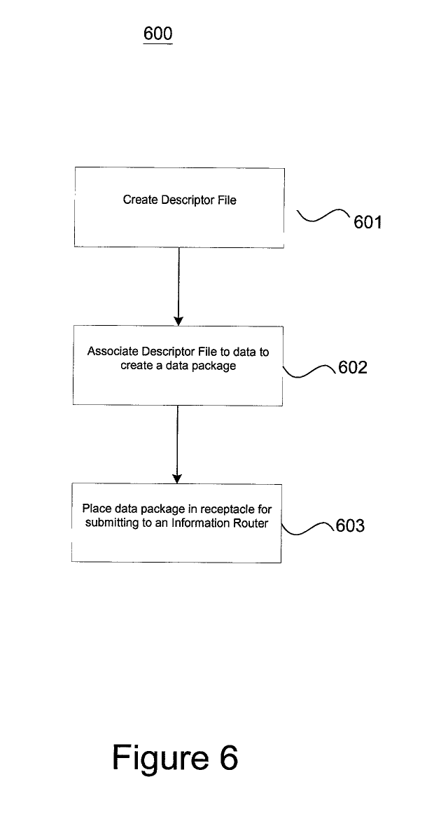

FIG. 6 is a flow diagram illustrating the steps performed during a process 600 for submitting data to the data processing system 102. At step 601, a descriptor file may be created for data to be transmitted to the data processing system 102. The descriptor file may include information about the data as described above with reference to FIG. 3.

At step 602, the descriptor file may be associated with the data to form a new data package. At step 603, the new data package may be placed in a receptacle for submitting to the data processing system 102. The receptacle may be an outbox 241-243 of one of the external systems 211-213 or one of the inboxes 231-233 of the information router 201. The fields of the descriptor file may include fields predefined in a routing table 400 of the data processing system 102. The routing table 400 of the data processing system 102 may be part of the information router 201, as described above with reference to FIGS. 3 and 4. The fields of the descriptor file and the corresponding routing table 400, may further include any other type of field. For example, if the new data package is an insurance file, the fields of the descriptor file may include a policy holder name field, a social security number field, a date of birth field, a doctor field, a provider field, a document type field and a destination system field. The new data package may also include attachments such as attending physician statements.

Thus, as has been illustrated herein, the system and process of the present invention enables a data processing system to process any new data package received, regardless of the format of the new data package. The system and method of the invention also eliminate the need to write application programs each time new systems are added to the data processing system.

While the foregoing description includes many details and specificities, it is to be understood that these details and specificities have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for routing information in a data processing system comprising the steps of:
checking an inbox periodically to determine if new data has been received in the inbox;
determining a destination for the new data based on a routing table associated with the inbox if new data has been received in the inbox; and
transmitting the new data to the determined destination.

2. The process of claim 1 wherein the step of checking the inbox periodically includes a sub-step of checking a plurality of inboxes periodically.

3. The process of claim 2 wherein each of the plurality of inboxes has a routing table associated with it.

4. The process of claim 1 wherein the step of determining the destination includes a sub-step of matching information in an index field of the new data with information in the routing table and reading destination information associated with the matching information in the routing table.

5. The process of claim 4 wherein the index field comprises one of each of a policy holder name, a social security number, a date of birth, a doctor name, a provider name, a type of document and a destination.

6. A method of routing information in a data processing system comprising the steps of:
receiving a data package including a descriptor file in a first inbox of an information router from a first external system;
recording the receipt of the data package in an event transaction logging database;
transmitting the data package to a package examination engine;
reading the descriptor file in the package examination engine;
comparing information in the descriptor file to a routing table;
following an error procedure included in the routing table if the information in the descriptor file does not match an entry in the routing table or if there is a package error; and
transmitting the data package to a destination system based on corresponding routing information included in the routing table if the information in the descriptor file matches an entry in the routing table.

7. The process of claim 6 wherein the step of transmitting the data package includes a sub-step of placing the package in a predetermined receptacle to await transmission to the destination system.

8. The process of claim 7 wherein the predetermined receptacle is one of an outbox of the information router and an inbox of the destination system.

9. The process of claim 6 wherein the step of following the error procedure includes a sub-step of placing the data package into an internal error document storage directory.

10. The process of claim 6 wherein the step following the error procedure includes a sub-step of transmitting the data package to a second external system for specialized handling.

11. The process of claim 6 further comprising a step of recording an entry into the event transaction logging database for each processing operation performed on the data package.

12. The process of claim 6 further comprising a step of pulling the data package into the first inbox of the information router from an outbox of the first external system.

13. The process of claim 6 further comprising a step of receiving the data package back from the destination system in a second inbox of the information router after the destination system has processed the data package.

14. The process of claim 13 wherein the first inbox of the information router and the second inbox of the information router are the same.

15. The process of claim 6 further comprising a step of creating the routing table to correspond to a predetermined data package format, the routing table having a plurality of fields.

16. The process of claim 15 wherein the routing table fields include at least one of a source system field, a source directory field, a criteria field, a destination system field, a destination directory field, an error system field and an error location field.

17. A method of monitoring one or more data packages routed through an information router comprising the steps of:
recording each transaction performed by the information router on each of the one or more data packages;
monitoring a location of each of the one or more data packages; and
transmitting information regarding the data package to a user.

18. The process of claim 17 wherein the step of recording each transaction includes a sub-step of recording at least one of a package arrival event, a package routing event, a package changing event and a package forwarding event.

19. The process of claim 17 further comprising assigning a unique transaction identification to each of the one or more data packages for recording information regarding each of the one or more data packages for a time when each of the one or more data packages enters the information router until another time when each of the one or more data packages leaves the information router.

20. The process of claim 17 wherein the step of recording each transaction includes a sub-step of recording each transaction in a database.

21. The process of claim 17 wherein the step of recording each transaction builds a complete tracking history of each of the one or more data packages for a time when each of the one or more data packages enters the information router until another time when each of the one or more data packages leaves the information router.

22. The process of claim 17 wherein the step of transmitting information regarding each of the one or more data packages to a user includes a sub-step of transmitting information concerning at least one of a number of the stops made by each of the one or more data packages, a time at which the at least one of the number of the stops was made by each of the one or more data packages, and a system to which the at least one of the one or more data packages was routed.

23. The process of claim 17 further comprising a step of scanning for any of the one or more data packages that have not been forwarded and determining at least one of an exact location of each of the one or more non-forwarded data packages and a forwarding location of each of the one or more data packages.

24. The process of claim 23 further comprising a step of using a query tool to scan for each of the one or more non-forwarded data packages.

25. The process of claim 17 further comprising the steps of:
generating a report including at least one of a plurality of system statistics and a plurality of data packages in error queues to users; and
transmitting the report over a network.

26. The process of claim 17 further comprising a step of downloading the information regarding each of the one or more data packages at a plurality of predetermined time intervals from the information router to an external database wherein the information regarding each of the one or more data packages from the information router may be combined with information regarding each of the one or more data packages from one or more external systems.

27. The process of claim 17 wherein the step of transmitting information regarding each of the one or more data packages includes a sub-step of transmitting information regarding each of the one or more data packages in response to a user request.

28. A system for routing information in a data processing system comprising:
an information router for routing a data package including
a package examination engine for reading a descriptor file for the data package including descriptive information about the data package;
a decision engine for comparing the descriptive information in the descriptor file to routing information in a routing table; and
a routing engine to route the data package to a destination system based on the routing information from the routing table, if the descriptive information in the descriptor file matches a routing information entry in the routing table, and to follow an internal error procedure if the descriptive information in the descriptor file does not match a routing information entry in the routing table or if there is a package error.

29. The system of claim 28 further comprising an event transaction logging database for recording each transaction performed by the information router on the data package.

30. The system of claim 29 wherein the event transaction logging database is configured to track at least one of a location of the data package and any non-forwarded data packages.

31. The system of claim 29 wherein the event transaction logging database is configured to build a tracking history of the data package.

32. The system of claim 29 wherein the event transaction logging database is configured to transmit information concerning the data package to a user.

33. The system of claim 29 further comprising a query tool to look up any non-forwarded data packages and to determine a current location of any such non-forwarded data package and a forwarding location for the non-forwarded data package.

34. The system of claim 29 further comprising a report generator to create a report including at least one of a plurality of system statistics and a plurality of documents in an error queue.

35. The system of claim 29 further comprising an external data warehouse to download data package information at a plurality of predetermined time intervals wherein the external data warehouse allows consolidation of data package information from the information router and external systems.

36. A method of submitting data to a data processing system comprising the steps of:
creating a descriptor file for the data, the descriptor file including information about the data;
associating the descriptor file with the data to form a data package; and
placing the data package in a receptacle for submitting to the data processing system.

37. The process of claim 36 wherein the step of placing the data package in a receptacle includes a sub-step of placing the data package in an outbox wherein the data processing system pulls the data package from the outbox.

38. The process of claim 36 wherein the step of placing the data package in a receptacle includes a sub-step of transmitting the data package to a data processing system inbox.

39. The process of claim 36 wherein the step of creating the descriptor file includes a sub-step of creating the descriptor file to include a plurality of predefined fields in a routing table of the data processing system.

40. The process of claim 39 wherein the plurality of predefined fields of the descriptor file include at least one of a name field, a customer number field, a source field, a data type field, and a files attached field.
